(19) United States
(12) Patent Application Publication
(10) Pub. No.: US 2014/0253556 A1
(43) Pub. Date: Sep. 11, 2014

(54) VISUALIZATION OF DYNAMIC, WEIGHTED NETWORKS

(71) Applicant: MICROSOFT CORPORATION, Redmond, WA (US)

(72) Inventors: Nathalie Henry Riche, Seattle, WA (US); Bongshin Lee, Issaquah, WA (US); Sheelagh Carpendale, Calgary (CA)

(73) Assignee: MICROSOFT CORPORATION, Redmond, WA (US)

(21) Appl. No.: 13/792,246

(22) Filed: Mar. 11, 2013

(51) Int. Cl. G06T 11/20

(52) U.S. Cl. CPC G06T 11/206
USPC 345/440

(57) ABSTRACT

A method, system, and one or more computer-readable storage media for a visualizing dynamic, weighted network are provided herein. The method includes generating, via a computing device, a table for visualizing a dynamic, weighted network. Each row of the table represents a link within the dynamic, weighted network. Each column of the table represents a time point, and each cell of the table includes a weight of a corresponding link at a corresponding time point. The method also includes manipulating the table to identify a pattern within the dynamic, weighted network in response to input by a user of the computing device.

### BACKGROUND

The visualization of graphs and networks has been an active research topic in the past two decades. In many cases, the visualization of graphs and networks may be used to identify patterns in graphs or networks that are evolving over time, such as web structures, software call graphs, biological networks, electrical networks, telecommunication networks, social networks, or the like. However, identifying patterns in such graphs or networks may be challenging because many nodes and links can be added or deleted over a short period of time. Further, this task may be even more challenging if the information carried on the links of a graph or network is of interest for the identification of patterns corresponding to the graph or network. For example, the weight of the connections in a functional brain network may be of interest for the identification of patterns between the connections within the brain. The identification of such patterns may allow scientists to improve their understanding of the manner in which the brain functions, as well as allow scientists to learn how to identify potential pathologies, such as Alzheimer or Parkinson's disease, in the early stages of development. Many existing visualization techniques use an animated representation to perform a visual exploration. However, as the human brain can track only a small number of elements (e.g., five elements) at a time, it is very difficult to extract high-level patterns using such animated representations.

### SUMMARY

The following presents a simplified summary of the subject innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

An embodiment provides a method for visualizing a dynamic, weighted network. The method includes generating, via a computing device, a table for visualizing a dynamic, weighted network. Each row of the table represents a link within the dynamic, weighted network. Each column of the table represents a time point, and each cell of the table includes a weight of a corresponding link at a corresponding time point. The method also includes manipulating the table to identify a pattern within the dynamic, weighted network in response to input by a user of the computing device.

Another embodiment provides a system for visualizing a dynamic, weighted network. The system includes a processor that is adapted to execute stored instructions and a system memory. The system memory includes code configured to generate a table for visualizing a dynamic, weighted network. Each row of the table represents a link within the dynamic, weighted network. Each column of the table represents a time point, and each cell of the table includes a weight of a corresponding link at a corresponding time point. The system memory also includes code configured to manipulate the table to identify a pattern within the dynamic, weighted network in response to input by a user.

In addition, another embodiment provides one or more computer-readable storage media for storing computer-readable instructions. The computer-readable instructions provide a system for visualizing a dynamic, weighted network when executed by one or more processing devices. The computer-readable instructions include code configured to generate a table for visualizing a dynamic, weighted network. Each row of the table represents a connection between two nodes within the dynamic, weighted network. Each column of the table represents a time point, and each cell of the table includes a strength of a corresponding connection at a corresponding time point. The computer-readable instructions also include code configured to aggregate, reorder, and filter any number of the columns and any number of the rows within the table to identify a high-level pattern within the dynamic, weighted network.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of a networking environment in which a system and method for visualizing dynamic, weighted networks may be implemented;

FIG. 2 is a block diagram of a computing environment that may be used to implement a system and method for visualizing dynamic, weighted networks;

FIG. 3 is a process flow diagram of a method for visualizing a dynamic, weighted network;

FIG. 4 is a table for visualizing a dynamic, weighted network;

FIG. 5 is a node-link diagram corresponding to the table of FIG. 4;

FIG. 6 is an aggregated table corresponding to the table of FIG. 4;

FIG. 7 is a node-link diagram for a functional brain network including twenty-three nodes;

FIG. 8 is a table for visualizing the functional brain network represented by the node-link diagram of FIGS. 7; and

FIG. 9 shows multiple levels of aggregation for the table of FIG. 8.

### DETAILED DESCRIPTION

As discussed above, the visualization of graphs and networks has been an active research topic in the past two decades. Researchers have made significant advances in representing graphs as node-link diagrams, in which vertices are represented as circles or rectangles and the edges are represented as line segments, polylines, or curves. In particular, researchers in graph drawing have largely investigated the problem of placing nodes in the Euclidean plane to optimize aesthetics criteria, such as minimizing edge crossings. Alternative representations that are based on adjacency matrices, in which vertices are represented by rows and columns of a table and edges connecting them are placed in the corresponding cell in the table, have also been explored. These representations eliminate the problem of node overlapping and edge crossings. However, such representations utilize a large amount of space and may prove difficult for certain tasks, such as following a path between two nodes that are not directly connected to each other.

While much work has been done for exploring static graphs, the visualization of static graphs' evolution over time is much more challenging, and relatively little research has been conducted in this area. The most well-known approach is the use of an animated node-link diagram to convey the evolution of the graph. Early work on the topic labeled the technique as dynamic graph drawing. The technique consists of generating a sequence of graphs for each time point and animating the layout from one step to the next to provide a smooth experience to the viewer. Additional animations help users follow changes such as fading in and out of nodes and edges as they appear in or disappear from the diagram Furthermore, researchers have investigated a similar animation technique for matrix visualization.

However, according to such animation techniques, certain patterns are challenging to discover due to the temporal nature of the animation. For example, it is difficult to remember the previously visited states of the graph or compare the previously visited states if the states do not appear consecutively in the animation. In addition, high-level patterns often occur over a long period of time, and the maintenance of a mental map may prove cognitively demanding. A solution to this problem is to display all the static graphs per time point. Since this approach utilizes a large amount of display space, it often uses a set of stacked layers in 2.5D or 3D space. However, stacking the static graphs together introduces additional visual clutter and does not scale well in the number of time points or size (i.e., the number of nodes and edges) of the graph.

To address this problem, recent work investigated the use of alternative static representations. For example, an “EdgeSplatting” technique linearizes each graph per time point to a vertical stripe. The hierarchically organized vertices of the graphs are arranged on vertical, parallel lines that bound the stripes. Directed edges between these vertices from left to right are used to represent graph evolution over time. A few researchers have also investigated the use of matrix representations, placing a bar chart or glyph in the cells of the matrix to indicate the evolution of the relationships. These techniques appear very promising as they do not rely on users maintaining a mental map of the graph, i.e., all the information is available in the static representation, and can scale in the amount of information represented in a single view. However, it remains difficult to extract high-level patterns on the evolving graph such as an overall evolution of the degree of many nodes in the graph.

A number of recent works introduced novel approaches to extract high-level patterns in graphs. For example, a “PivotGraph” technique and a “HoneyComb” technique aggregate the graph based on its data attributes, supporting the discovery of relationships between attributes carried by nodes. In addition, a “GraphPrism” technique uses graph-theoretic properties such as the diameter to characterize the structure of large networks. However, none of these approaches have been applied to the analysis of dynamic, weighted graphs or networks.

Accordingly, embodiments described herein are directed to the visualization of dynamic, weighted networks, which may allow for the identification of patterns of connectivity within the dynamic, weighted networks. In various embodiments, the visualization includes an interactive visualization in which a viewer or analyst is provided with all the links in the network in a table containing pairwise connections, i.e., links, in rows and time in columns. Each link may include a source vertex and a target vertex. The cells of the table may contain the strength of each connection at each time point. A user may interact with the visualization by aggregating or sorting rows and columns to discover high-level patterns within the dynamic, weighted network.

According to embodiments described herein, the term “network” may be used interchangeably with the term “graph,” and may be used to indicate any type of network or graph that may be visualized to identify patterns. For example, such networks or graphs may include web structures, software call graphs, biological networks, electrical networks, telecommunication networks, social networks, or the like. As used herein, the term “dynamic” may be used to indicate a network that is continuously evolving over time. In addition, as used herein, the term “weighted” may be used to indicate a network including connections of varying strengths.

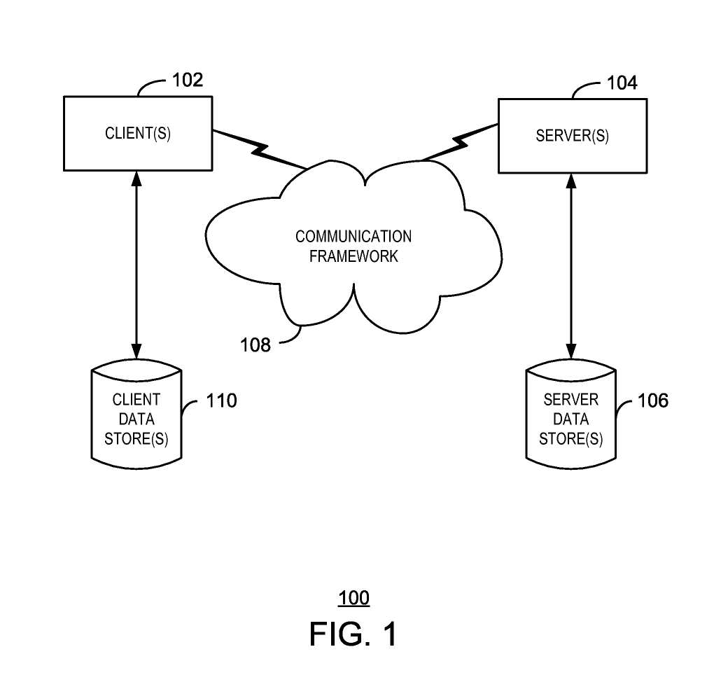

As a preliminary matter, some of the figures describe concepts in the context of one or more structural components, variously referred to as functionality, modules, features, elements, or the like. The various components shown in the figures can be implemented in any manner, such as via software, hardware (e.g., discrete logic components), or firmware, or any combinations thereof. In some embodiments, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like.

The term “logic” encompasses any functionality for performing a task. For instance, each operation illustrated in the flowcharts corresponds to logic for performing that operation. An operation can be performed using, for instance, software, hardware, firmware, or the like.

As used herein, the terms “component,” “system,” “client,” “search engine,” “browser,” “server,” and the like are intended to refer to a computer-related entity, either hardware, software (e.g., in execution), or firmware, or any combination thereof. For example, a component can be a process running on a processor, an object, an executable, a program, a function, a library, a subroutine, a computer, or a combination of software and hardware.

By way of illustration, both an application running on a server and the server can be a component. One or more components can reside within a process, and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable storage device or media.

Computer-readable storage media can include but are not limited to magnetic storage devices (e.g., hard disk, floppy disk, and magnetic strips, among others), optical disks (e.g., compact disk (CD) and digital versatile disk (DVD), among others), smart cards, and flash memory devices (e.g., card, stick, and key drive, among others). In contrast, computer-readable media (i.e., not storage media) generally may additionally include communication media such as transmission media for wireless signals and the like.

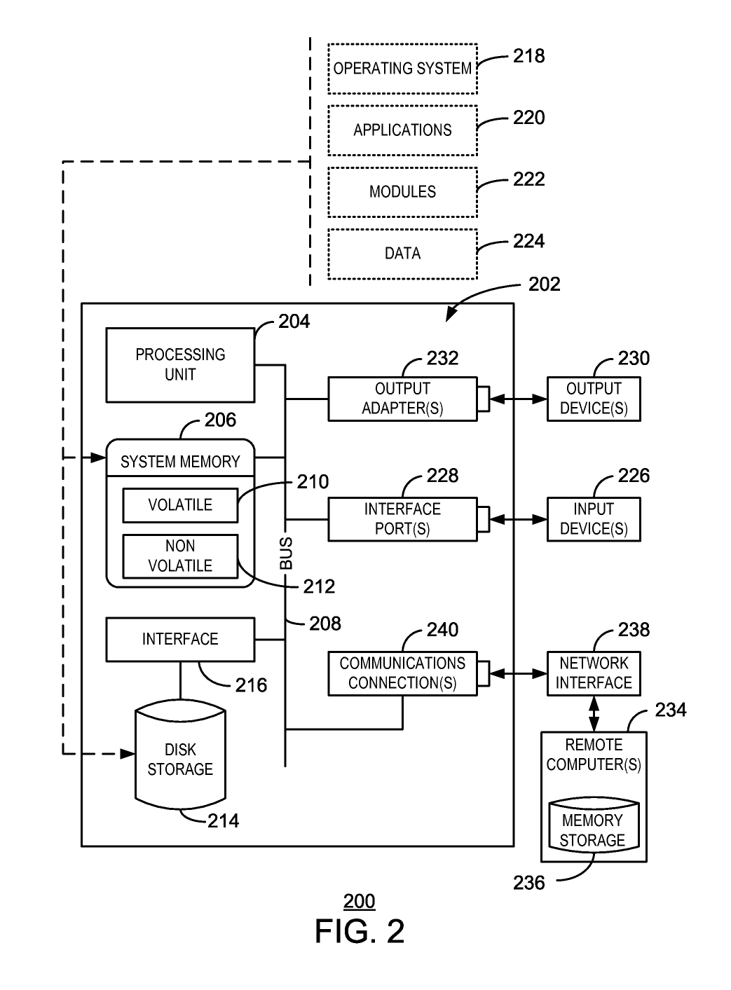

In order to provide context for implementing various aspects of the claimed subject matter, FIGS. 1-2 and the following discussion are intended to provide a brief, general description of a computing environment in which the various aspects of the subject innovation may be implemented. For example, a method and system for visualizing dynamic, weighted networks can be implemented in such a computing environment. While the claimed subject matter has been described above in the general context of computer-executable instructions of a computer program that runs on a local computer or remote computer, those of skill in the art will recognize that the subject innovation also may be implemented in combination with other program modules. Generally, program modules include routines, programs, components, data structures, or the like that perform particular tasks or implement particular abstract data types.

Moreover, those of skill in the art will appreciate that the subject innovation may be practiced with other computer system configurations. For example, the subject innovation may be practiced with single-processor or multi-processor computer systems, minicomputers, mainframe computers, personal computers, hand-held computing devices, microprocessor-based or programmable consumer electronics, or the like, each of which may operatively communicate with one or more associated devices. The illustrated aspects of the claimed subject matter may also be practiced in distributed computing environments wherein certain tasks are performed by remote processing devices that are linked through a communications network. However, some, if not all, aspects of the subject innovation may be practiced on stand-alone computers. In a distributed computing environment, program modules may be located in local or remote memory storage devices.

FIG. 1 is a block diagram of a networking environment 100 in which a system and method for visualizing dynamic, weighted networks may be implemented. The networking environment 100 includes one or more client(s) 102. The client(s) 102 can be hardware and/or software (e.g., threads, processes, or computing devices). The networking environment 100 also includes one or more server(s) 104. The server(s) 104 can be hardware and/or software (e.g., threads, processes, or computing devices). The server(s) 104 can house threads to perform search operations by employing the subject innovation, for example.

One possible communication between a client 102 and a server 104 can be in the form of a data packet adapted to be transmitted between two or more computer processes. The networking environment 100 includes a communication framework 108 that can be employed to facilitate communications between the client(s) 102 and the server(s) 104. The client(s) 102 are operably connected to one or more client data store(s) 110 that can be employed to store information local to the client(s) 102. The client data store(s) 110 may be stored in the client(s) 102, or may be located remotely, such as in a cloud server. Similarly, the server(s) 104 are operably connected to one or more server data store(s) 106 that can be employed to store information local to the servers 104.

FIG. 2 is a block diagram of a computing environment that may be used to implement a system and method for visualizing dynamic, weighted networks. The computing environment 200 includes a computer 202. The computer 202 includes a processing unit 204, a system memory 206, and a system bus 208. The system bus 208 couples system components including, but not limited to, the system memory 206 to the processing unit 204. The processing unit 204 can be any of various available processors. Dual microprocessors and other multiprocessor architectures also can be employed as the processing unit 204.

The system bus 208 can be any of several types of bus structures, including the memory bus or memory controller, a peripheral bus or external bus, or a local bus using any variety of available bus architectures known to those of ordinary skill in the art. The system memory 206 is computer-readable storage media that includes volatile memory 210 and non-volatile memory 212. The basic input/output system (BIOS), containing the basic routines to transfer information between elements within the computer 202, such as during start-up, is stored in non-volatile memory 212. By way of illustration, and not limitation, non-volatile memory 212 can include read-only memory (ROM), programmable ROM (PROM), electrically-programmable ROM (EPROM), electrically-erasable programmable ROM (EEPROM), or flash memory.

Volatile memory 210 includes random access memory (RAM), which acts as external cache memory. By way of illustration and not limitation, RAM is available in many forms, such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 202 also includes other computer-readable storage media, such as removable/non-removable, volatile/non-volatile computer storage media. FIG. 2 shows, for example, a disk storage 214. Disk storage 214 may include, but is not limited to, a magnetic disk drive, floppy disk drive, tape drive, Jaz drive, Zip drive, LS-100 drive, flash memory card, or memory stick.

In addition, disk storage 214 can include storage media separately or in combination with other storage media including, but not limited to, an optical disk drive such as a compact disk ROM device (CD-ROM), CD recordable drive (CD-R Drive), CD rewritable drive (CD-RW Drive), or a digital versatile disk ROM drive (DVD-ROM). To facilitate connection of the disk storage 214 to the system bus 208, a removable or non- removable interface is typically used, such as interface 216.

It is to be appreciated that FIG. 2 describes software that acts as an intermediary between users and the basic computer resources described in the computing environment 200. Such software includes an operating system 218. The operating system 218, which can be stored on disk storage 214, acts to control and allocate resources of the computer 202.

System applications 220 take advantage of the management of resources by the operating system 218 through program modules 222 and program data 224 stored either in system memory 206 or on disk storage 214. It is to be appreciated that the claimed subject matter can be implemented with various operating systems or combinations of operating systems.

A user enters commands or information into the computer 202 through input devices 226. Input devices 226 can include, but are not limited to, a pointing device (such as a mouse, trackball, stylus, or the like), a keyboard, a microphone, a gesture or touch input device, a voice input device, a joystick, a satellite dish, a scanner, a TV tuner card, a digital camera, a digital video camera, a web camera, or the like. The input devices 226 connect to the processing unit 204 through the system bus 208 via interface port(s) 228. Interface port(s) 228 can include, for example, a serial port, a parallel port, a game port, and a universal serial bus (USB). Output device(s) 230 may also use the same types of ports as input device(s) 226. Thus, for example, a USB port may be used to provide input to the computer 202 and to output information from the computer 202 to an output device 230.

An output adapter 232 is provided to illustrate that there are some output devices 230 like monitors, speakers, and printers, among other output devices 230, which are accessible via the output adapters 232. The output adapters 232 include, by way of illustration and not limitation, video and sound cards that provide a means of connection between the output device 230 and the system bus 208. It can be noted that other devices and/or systems of devices provide both input and output capabilities, such as remote computer(s) 234.

The computer 202 can be a server hosting an event forecasting system in a networking environment, such as the networking environment 100, using logical connections to one or more remote computers, such as remote computer(s) 234. The remote computer(s) 234 may be client systems configured with web browsers, PC applications, mobile phone applications, and the like. The remote computer(s) 234 can be a personal computer, a server, a router, a network PC, a workstation, a microprocessor based appliance, a mobile phone, a peer device or other common network node and the like, and typically includes many or all of the elements described relative to the computer 202. For purposes of brevity, the remote computer(s) 234 are illustrated with a memory storage device 236. The remote computer(s) 234 are logically connected to the computer 202 through a network interface 238, and physically connected to the computer 202 via a communication connection 240.

Network interface 238 encompasses wired and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 240 refers to the hardware and/or software employed to connect the network interface 238 to the system bus 208. While communication connection 240 is shown for illustrative clarity inside the computer 202, it can also be external to the computer 202. The hardware and/or software for connection to the network interface 238 may include, for example, internal and external technologies such as mobile phone switches, modems including regular telephone grade modems, cable modems and DSL modems, ISDN adapters, and Ethernet cards.

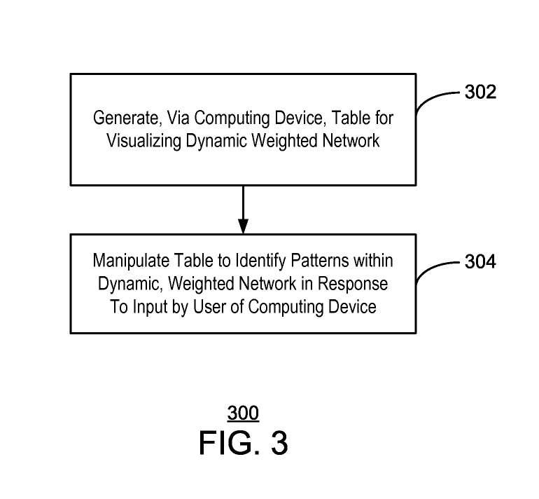

FIG. 3 is a process flow diagram of a method 300 for visualizing a dynamic, weighted network. The method 300 may be implemented within the networking environment 100 of FIG. 1 and/or the computing environment 200 of FIG. 2. In various embodiments, the method 300 is used to visualize the manner in which the weights (i.e., strengths) of links (i.e, connections between nodes) within a dynamic, weighted network evolve over time. High-level patterns within the dynamic, weighted network may then be identified based on the visualization, as discussed further below.

The method 300 begins at block 302, at which a table for visualizing a dynamic, weighted network is generated via a computing device. Each row of the table represents a link within the dynamic, weighted network. Each column of the table represents a specific time point, and each cell of the table represents a weight of a corresponding link at a corresponding time point. In various embodiments, the rows of the table are depicted as stream graphs (or area line charts) showing the evolution (i.e., change in weight) of corresponding links over time.

At block 304, the table is manipulated to identify a pattern within the dynamic, weighted network in response to input by a user of the computing device. The identified pattern may be any type of high-level pattern corresponding to one or more links within the dynamic, weighted network. In various embodiments, manipulating the table includes aggregating, reordering, and/or filtering any of the columns and/or any of the rows of the table. In some embodiments, a particular row within the table may be analyzed to visualize an evolution of a corresponding link over time. In other embodiments, multi-level aggregation may be performed by aggregating a number of rows to visualize an evolution of a number of corresponding links over time. In various embodiments, particular columns and/or rows within the table may be reordered via the computing device according to an automatic sorting procedure in response to a single input by the user, or may be manually reordered in response to specific input by the user. Further, in some embodiments, particular columns and/or rows within the table may be filtered to hide the rows and/or columns from the visualization. For example, if the user desires to visualize the evolution of a particular set of links within the dynamic, weighted network, the cells corresponding to all the other links within the dynamic, weighted network may be hidden from the table.

In various embodiments, a node-link diagram representing a weight of each link within the dynamic, weighted graph at a particular time point may be generated by aggregating a number of cells corresponding to different rows and a same column within the table. The node-link diagram may then be tightly coupled to the table. The tight coupling of the node-link diagram to the table may allow a user's selections and/or manipulations to the table to be immediately reflected in the node-link diagram, or vice versa. For example, when the user places the mouse pointer on a cell of the table, the corresponding nodes and connection for this time point are highlighted in the node-link diagram. Further, any other suitable types of graphical visualizations, such as matrix visualizations, may also be generated based on the table, and may be tightly coupled to the table.

The process flow diagram of FIG. 3 is not intended to indicate that the blocks of the method 300 are to be executed in any particular order, or that all of the blocks are to be included in every case. Further, any number of additional blocks not shown in FIG. 3 may be included within the method 300, depending on the details of the specific implementation.

The method 300 may be used for a variety of applications. In some embodiments, if the dynamic, weighted network is a functional brain network, a pattern between various brain regions or connections within the brain may be determined according to the method 300. For example, the method 300 may be used to determine how regions within the brain that control language communicate with each other, or how regions within the brain that control language communicate with or correspond to regions within the brain that control vision. In other embodiments, if the dynamic, weighted network is a social network, a pattern between various users of the social network may be determined according to the method 300. For example, the weight of a link between two users may be determined based on a number of emails that are sent between the two users, and the evolution of the link between the two users may be tracked over a specific period of time.

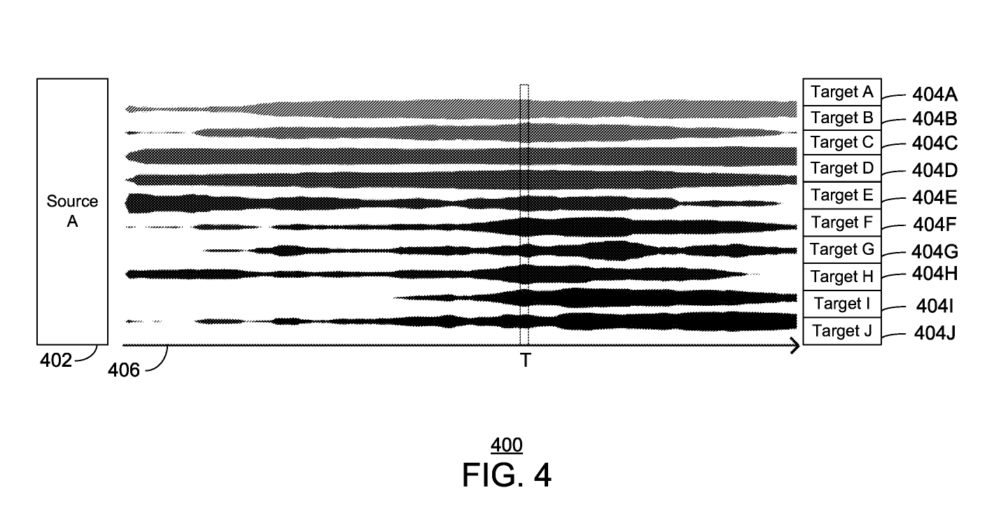

FIG. 4 is a table 400 for visualizing a dynamic, weighted network. The table 400 represents a visual adjacency list of all links, or connections, of a given source vertex 402, i.e., Source A, with a number of different target vertices 404A-J, i.e., Targets A-J. In various embodiments, the target vertices 404 belong to two distinct groups. For example, targets vertices 404A-E, i.e., Targets A-E, may belong to a first group, and target vertices 404F-J, i.e., Targets F-J, may belong to a second group.

A horizontal axis 406 of the table 400 represents the time. The variation of height for each row within the table 400 indicates the strength, or weight, of each link over time. For example, as shown in FIG. 4, the strength of each link may be determined for a specific time point, T, based on the height of the band in the cell corresponding to each link at the specific time point.

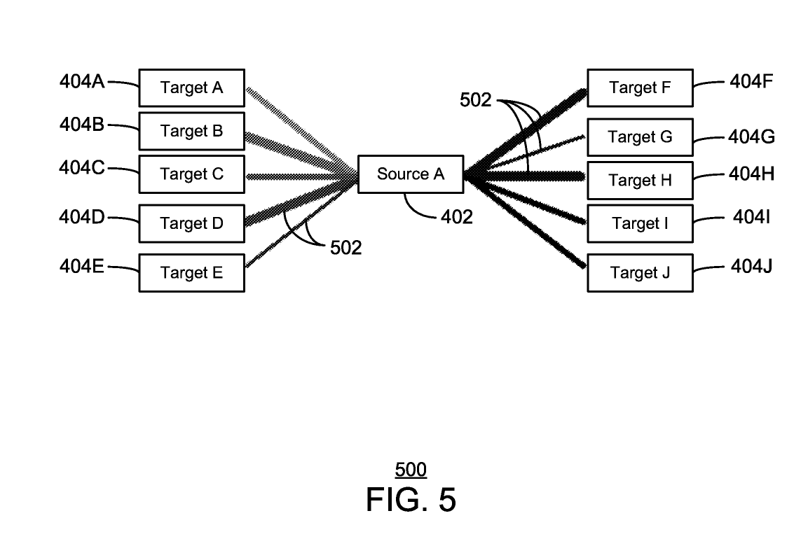

FIG. 5 is a node-link diagram 500 corresponding to the table 400 of FIG. 4. Like numbered items are as described with respect to FIG. 4. Within the node-link diagram 500, the target vertices 404 may be split into the two distinct groups, i.e., target vertices 404A-E and target vertices 404F-J. The node-link diagram 500 represents the strength of each link at the specific time point, T. Specifically, the strength of each link is indicated by the thickness of the lines 502 connecting the source vertex 402 to the target vertices 404A-J.

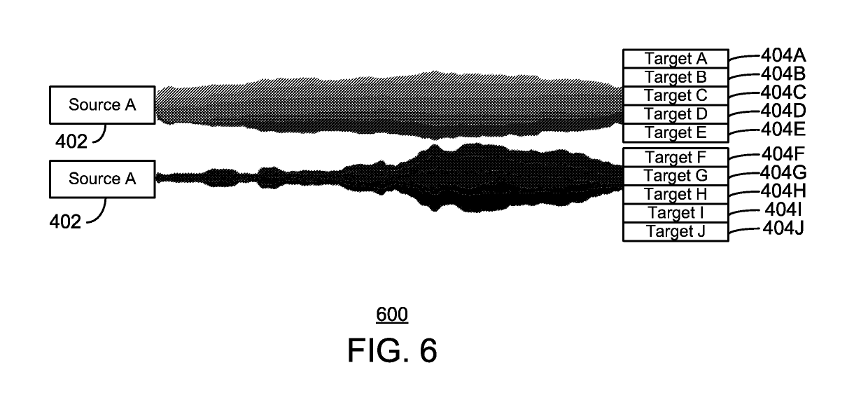

FIG. 6 is an aggregated table 600 corresponding to the table 400 of FIG. 4. Like numbered items are as described with respect to FIG. 4. The aggregated table 600 represents a visual adjacency list of all links of the source vertex 402 with the target vertices 404A-J after aggregation of the rows for each distinct group of target vertices 404, i.e., target vertices 404A-E and target vertices 404F-J. The strengths of the links within each group of target vertices 404A-J are stacked. However, the strength of each individual link can still be determined from the aggregated table 600.

In various embodiments, aggregation of the table 600 allows the user to detect high-level patterns of connections at the group level instead of the individual target vertex level. For example, as shown in FIG. 6, aggregation of the first group of target vertices 404A-E reveals that the strengths of the links between the source vertex 402 and the target vertices 404A-E are slightly increasing over time. In addition, aggregation of the second group of target vertices 404F-J reveals that the strengths of the links between the source vertex 402 and the target vertices 404F-J are more variable and are strongly increasing starting about halfway through the time period.

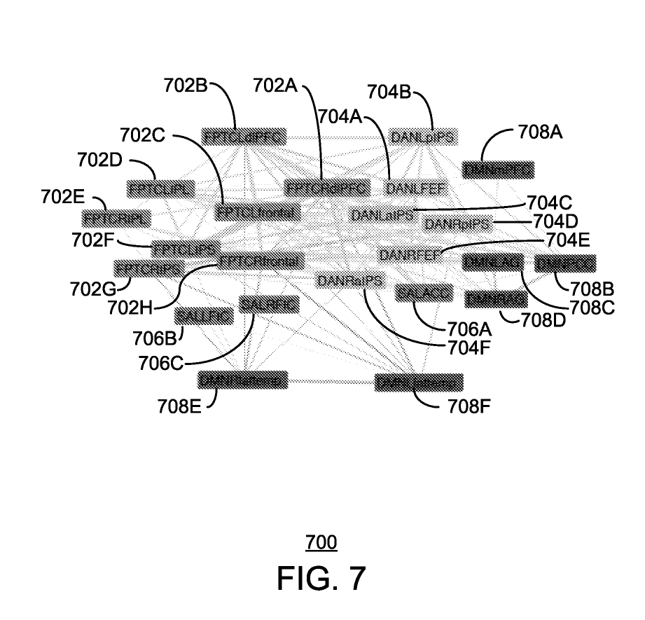

FIG. 7 is a node-link diagram 700 for a functional brain network including twenty-three nodes. The nodes may be split into four distinct groups, where each group may represent a different region of the brain, for example. The first group includes eight nodes 702A-H that are designated by “FPT.” The second group includes six nodes 704A-F that are designated by “DAN.” The third group includes three nodes 706A-C that are designated by “SAL.” The fourth group includes six nodes 708A-F that are designated by “DMN.”

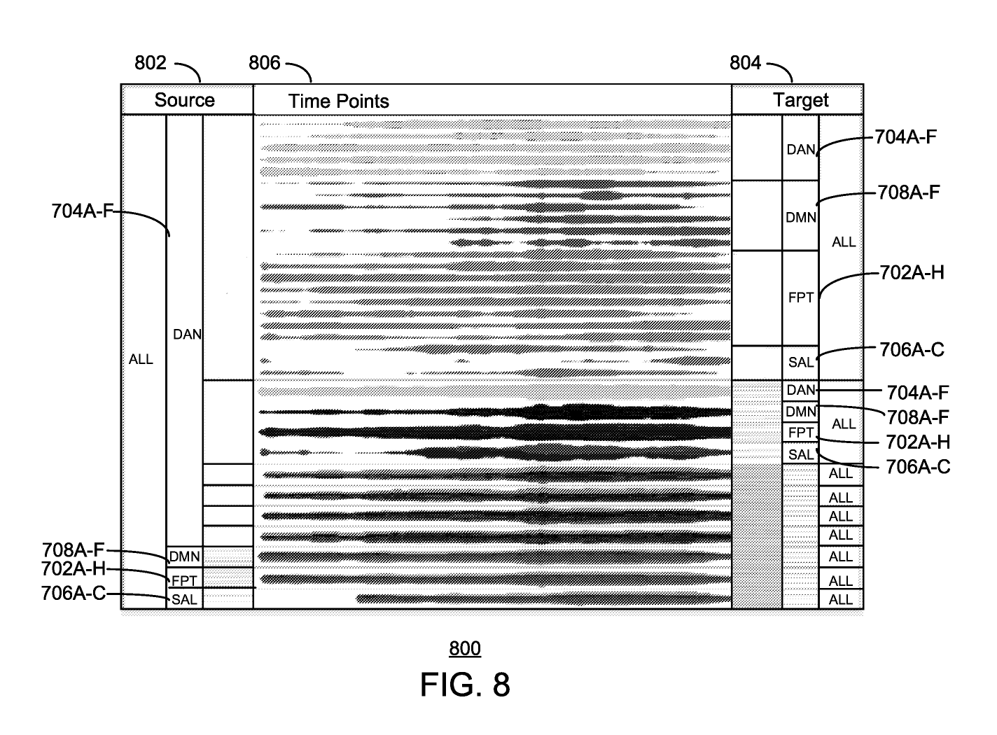

The node-link diagram 700 represents the strength of each link at a specific time point. Specifically, the strength of each link is indicated by the thickness of the lines connecting the nodes. In many cases, however, the number of links and link crossings makes it difficult to extract information such a diagram, even for a given time point. Therefore, as discussed further with respect to FIG. 8, a table may be used to represent the strengths of the links within the functional brain network over time.

FIG. 8 is a table 800 for visualizing the functional brain network represented by the node-link diagram 700 of FIG. 7. Like numbered items are as described with respect to FIG. 7. The table 800 represents a visual adjacency list of all links between the nodes within the functional brain network. Each node within the functional brain network may be both a source vertex 802 and a target vertex 804 within the table 800.

The table 800 shows a strength of each link over 140 time points 806. Each time point 806 represents a specific period of time, such as, for example, 2 seconds. In some embodiments, the table 800 can be hierarchically aggregated to show larger time points.

The rows of the table 800 are aggregated by the source vertices 402 and the target vertices 404. The leftmost column of the table 800 includes a hierarchical tree conveying the aggregation structure of the source vertices 802, and the rightmost column of the table 800 includes a hierarchical tree conveying the aggregation structure of the target vertices 804. For each time point and aggregated source vertex/target vertex pair, the corresponding cell within the table 800 includes a visual element encoding the strength of the connection between the source vertex 802 and the target vertex 804 by its height. In addition, the cell may include a visual element that conveys the specific group to which the target vertex 804 belongs, such as via shading or coloring.

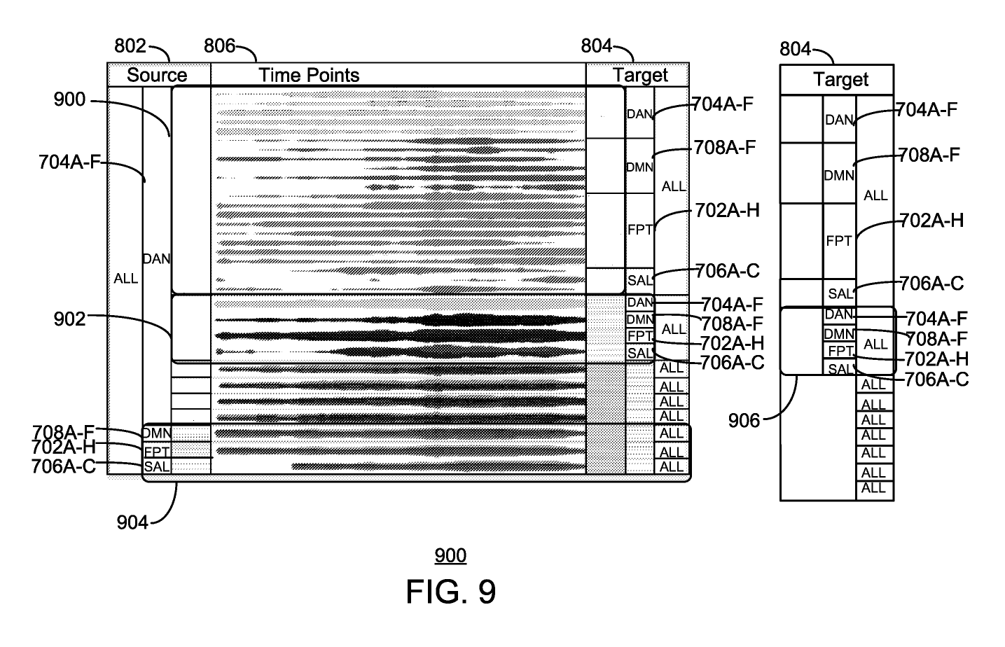

FIG. 9 shows multiple levels of aggregation for the table 800 of FIG. 8. Like numbered items are as described with respect to FIGS. 7 and 8. A first portion 900 of the table 800 presents no aggregation. Each row encodes the variation over time of the strength of a link in the functional brain network. For example, the strengths of the links between the node DANLaIPS and the other twenty-two nodes are shown individually in the first portion 900 of the table 800. In some embodiments, the links may be shaded or colored according to the group of the target vertex 804.

A second portion 902 of the table 800 shows an aggregation of the links between one source vertex 802 and a group of target vertices 804. For example, the strengths of the links between the DANLFEF node and the other twenty-two nodes are grouped into four categories, i.e., DAN nodes 704A-F, DMN nodes 708A-F, FPT nodes 702A-H, and SAL nodes 706A-C. Each row is an aggregation of multiple connections. An indication of the number of links aggregated is given in the tree visualization on the right side.

A third portion 904 of the table 800 shows the connections between a group of nodes and all the other nodes within the functional brain network. For example, the first row may be the aggregation of connections from the six DMN nodes 708A-F to all the other nodes. Thus, the first row may be an aggregation of 132 connections, i.e., 6*22 connections.

A fourth portion 906 of the table 800 shows a branch of the hierarchical tree visualization. The first column indicates the individual target vertices 804. The second column indicates the groups to which the target vertices 804 belong, and the last column indicates all the nodes within the functional brain network. In various embodiments, the visual encoding of the first column allows the user to easily recognize various features of the table 800, such as that there are only three SAL nodes 706A-C.

It is to be understood that the tables and node-link diagrams described with respect t to FIGS. 4-9 are merely exemplary embodiments of the techniques described herein. Moreover, the techniques described herein may use any variation of the tables and/or node-link diagrams described with respect to FIGS. 4-9, or may use entirely different tables and/or node-link diagrams, depending on the details of the specific implementation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for visualizing a dynamic, weighted network, comprising:
generating, via a computing device, a table for visualizing a dynamic, weighted network, wherein each row of the table comprises a link within the dynamic, weighted network, each column of the table comprises a time point, and each cell of the table comprises a weight of a corresponding link at a corresponding time point; and
manipulating the table to identify a pattern within the dynamic, weighted network in response to input by a user of the computing device.

2. The method of claim 1, wherein manipulating the table comprises analyzing a particular row within the table to visualize an evolution of a corresponding link over a specific period of time.

3. The method of claim 1, wherein manipulating the table comprises aggregating any of the columns and/or any of the rows within the table.

4. The method of claim 3, comprising performing multi-level aggregation by aggregating a plurality of rows to visualize an evolution of a plurality of corresponding links over time.

5. The method of claim 1, wherein manipulating the table comprises reordering any of the columns and/or any of the rows within the table.

6. The method of claim 5, wherein reordering any of the columns and/or any of the rows within the table comprises performing an automatic sorting procedure via the computing device in response to input by the user.

7. The method of claim 5, wherein reordering any of the columns and/or any within the rows of the table comprises manually rearranging any of the columns and/or any of the rows within table in response to input by the user.

8. The method of claim 1, wherein manipulating the table comprises filtering any of the columns and/or any of the rows within the table.

9. The method of claim 8, comprising:
generating a graphical visualization representing a weight of each of a plurality of links within the dynamic, weighted graph at a particular time point by aggregating a plurality of cells corresponding to different rows and a same column within the table; and
tightly coupling the table to the graphical visualization.

10. The method of claim 1, comprising representing each row within the table as a stream graph showing an evolution of a corresponding link over time.

11. A computing system for visualizing a dynamic, weighted network, comprising:
a processor that is adapted to execute stored instructions; and
a system memory, wherein the system memory comprises code configured to:
generate a table for visualizing a dynamic, weighted network, wherein each row of the table comprises a link within the dynamic, weighted network, each column of the table comprises a time point, and each cell of the table comprises a weight of a corresponding link at a corresponding time point; and
manipulate the table to identify a pattern within the dynamic, weighted network in response to input by a user.

12. The system of claim 11, wherein the system memory comprises code configured to manipulate the table by aggregating any of the columns and/or any of the rows within the table.

13. The system of claim 12, wherein the system memory comprises code configured to perform multi-level aggregation of a plurality of columns and a plurality of rows within the table.

14. The system of claim 11, wherein the system memory comprises code configured to manipulate the table by reordering any of the columns and/or any of the rows within the table.

15. The system of claim 11, wherein the system memory comprises code configured to manipulate the table by filtering any of the columns and/or any of the rows within the table.

16. The system of claim 11, wherein the system memory comprises code configured to tightly couple the table to a graphical visualization corresponding to the table.

17. The system of claim 11, wherein the system memory comprises code configured to generate a node-link diagram representing a weight of each of a plurality of links within the dynamic, weighted graph at a particular time point by aggregating a plurality of cells corresponding to different rows and a same column within the table.

18. The system of claim 17, wherein the system memory comprises code configured to tightly couple the table to the node-link diagram

19. One or more computer-readable storage media for storing computer-readable instructions, the computer-readable instructions providing a system for visualizing a dynamic, weighted network when executed by one or more processing devices, the computer-readable instructions comprising code configured to:
generate a table for visualizing the dynamic, weighted network, wherein each row of the table comprises a connection between two nodes within the dynamic, weighted network, each column of the table comprises a time point, and each cell of the table comprises a strength of a corresponding connection at a corresponding time point; and
aggregate, reorder, and filter any number of the columns and any number of the rows within the table to identify a pattern within the dynamic, weighted network.

20. The one or more computer-readable storage media of claim 19, wherein the computer-readable instructions comprise code configured to tightly couple the table to a graphical visualization corresponding to the table.
